(19) United States
(12) Patent Application Publication
(10) Pub. No.: US 2007/0280423 A1
(43) Pub. Date: Dec. 6, 2007

(54) REGISTRATION BY MEANS OF RADIATION MARKING ELEMENTS

(76) Inventor: Robert Schmidt, Munchen (DE)

Correspondence Address: DON W. BULSON (BrainLAB), RENNER, OTTO, BOISSELLE & SKLAR, LLP, 1621 EUCLID AVENUE - 19TH FLOOR, CLEVELAND, OH, 44115, US

(21) Appl. No.: 11/753,046

(22) Filed: May 24, 2007

Related U.S. Application Data
(60) Provisional application No. 60/806,502, filed on Jul. 3, 2006.

(30) Foreign Application Priority Data
May 31, 2006 (EP) 06 011 219.0

(51) Int. Cl. H05G 1/28

(52) U.S. Cl. 378/165

(57) ABSTRACT

A method for registering at least a part of an object includes applying a substance to at least a part of the surface of the object, wherein the substance includes a plurality of radiation marking elements that emit radiation. At least one camera is used to scan the surface of the object such that at least a portion of the plurality of radiation marking elements are detected by the at least one camera, and three-dimensional spatial positions of the detected portion of the plurality of radiation marking elements relative to a reference coordinate system are ascertained based on the radiation emitted from the marking elements and detected by the camera and a three-dimensional position and/or orientation of the camera relative to the reference coordinate system. The object then is registered on the basis of the three-dimensional spatial positions of the detected portion of the plurality of radiation marking elements.

### RELATED APPLICATION DATA

This application claims priority of U.S. Provisional Application No. 60/806,502 filed on Jul. 3, 2006, which is incorporated herein by reference in its entirety.

### FIELD OF THE INVENTION

The invention relates to registration of an object in the context of medical navigation. More particularly, the invention relates to a method and device for registering an object or part thereof, such as a body or part of a patient's body, for use in a medical navigation system, wherein a substance containing radiation marking elements is applied to the surface of the object. The radiation marking elements may be positionally detected by at least one tracking device, thereby enabling registration of the object.

### BACKGROUND OF THE INVENTION

Known methods and devices for medical registration of an object (including surface registration) are based on laser scanning or mechanical scanning. In laser scanning, the surface of an object may be scanned using a contactless registration device that emits light (e.g., visible or infrared light) on a surface of the object. A tracking device then detects the spatial position of the light on the surface of the object and uses this data to register the object with previously obtained data. Examples of devices that may be used for contactless registration include infrared laser light pointers sold under the tradename Z-touch® by BrainLab AG, or the contour laser system sold under the tradename Fazer by Medtronic, Inc.

The surface of an object also may be scanned and then registered by means of mechanical contact using a so-called soft-touch system. In a soft touch system, a tip of a registration device includes a sensor that detects the moment when contact is made with the surface of the object. At the moment contact is made, the location of the pointer tip can be ascertain prior to distortion of the object surface (e.g., prior to the tip pushing in or dimpling the skin surface).

While the above methods are effective in registering objects, they require additional hardware, namely the contactless or mechanical scanners.

### SUMMARY OF THE INVENTION

In a method for registering an object or at least a part thereof, such as a body or part of a patient's body, a substance is applied to a part of the surface of the object, such as an arm or leg or other body part. The applied substance, which can be a paint, liquid, cream, paste, or gel, for example, contains a plurality of radiation marking elements (e.g., quantum dots). The radiation marking elements are distributed on the object by applying the substance onto the object. Preferably, the radiation marking elements are uniformly distributed over at least a portion of the object. The radiation marking elements can emit radiation, in particular in the infrared range, or can be excited into one or more states in which they emit radiation.

If the substance is applied to at least a part of the surface of the object or body part, and the radiation marking elements contained in the substance are distributed on the surface of the object, then the radiation marking elements or at least a part of the radiation marking elements can be detected by means of a camera (e.g., an infrared camera) that detects the radiation emitted therefrom. The camera, for example, can be configured and/or arranged such that it can detect the radiation marking elements in a first position and/or orientation relative to the object or body part. The camera and/or object then can be moved to a second position and/or orientation relative to the object, the second position and/or orientation being different from the first position and/or orientation, wherein the camera can again detect the radiation marking elements.

The camera also can be arranged and/or configured such that it detects at least a part of the radiation marking elements in at least one first position and/or orientation relative to the object or body part. The camera and/or object then can be moved to at least one second position and/or orientation relative to the object, the at least one second position and/or orientation being different from the first position and/or orientation, so as to detect at least the radiation marking elements not detected by the camera in the first position and/or orientation of the camera. In particular, the camera can be configured to be movable relative to the object or body part and can be moved from the at least one first position and/or orientation to the at least one second position and/or orientation relative to the object. The camera is preferably configured such that it can be moved at least around a part of the object or completely around the object, in order to detect the radiation marking elements on the surface of the object.

Instead of a single camera, two cameras may be used, wherein a first camera can be positioned at a first fixed or variable position and/or orientation, and a second camera can be positioned at a second fixed or variable position and/or orientation, different from the first position and/or orientation, relative to the object or body part. In the first position and/or orientation of the first camera, a part of the radiation marking elements or all of the radiation marking elements on the surface of the object can be detected by the first camera. In the second position and/or orientation of the second camera, a part of the radiation marking elements or all of the radiation marking elements can be detected by the second camera. Preferably, the second camera detects at least the radiation marking elements not detected by the first camera in the first position and/or orientation.

In addition to the one or two camera embodiments described above, additional cameras may be used to detect the radiation marking elements (e.g., three, four, five, six or more cameras).

The position and/or orientation of the camera or cameras may be known or can be ascertained relative to a reference coordinate system, such as a fixed or non-varying global coordinate system. The camera or cameras, for example, can be moved to one or more predetermined or known positions and/or orientations, in which they detect the radiation marking elements or the radiation of the radiation marking elements. A tracking reference or reference star also can be arranged on the at least one camera and, for example, detected by a tracking system. Via the tracking system, the position and/or orientation of the reference star and therefore the position and/or orientation of the at least one camera can be ascertained relative to the reference or global coordinate system.

The position and/or orientation of the at least one camera, for example, can be continuously ascertained, independent of its respective position. The position and/or orientation of the at least one camera is preferably ascertained in the position and/or orientation in which it scans or records the object or body part in order to detect the radiation marking elements.

By taking into account the position and/or orientation of the at least one camera relative to the reference coordinate system, and from the locations of the radiation marking elements as detected by the at least one camera, the three-dimensional spatial position of the radiation marking elements can be ascertained relative to the reference coordinate system. Thus, the position of the radiation marking elements on the surface of the object is known in a global coordinate system, and the object or the surface of the object or body part can be registered on the basis of the three-dimensional spatial positions of the radiation marking elements.

The radiation marking elements can be detected from at least two different positions and/or orientations by the at least one camera. For example, a single camera can be moved to different positions and/or orientations, wherein data is obtained by the single camera in each position and/or orientation. Alternatively, multiple cameras can be positioned or arranged in different positions and/or orientations, fixed or movable relative to the object or body part, and data may be obtained from each camera.

Any substances that can be applied to the surface of the object, such as part of the patient's body, in particular a face or the upper body or a patient's arm or leg, can be used as the substance. A paint, liquid, cream, paste, gel or other substance that can be applied may be used. The radiation marking elements are preferably mixed uniformly with or into the substance, such that once the substance has been applied to the object or part of the patient's body, the radiation markers are distributed substantially uniformly over most of the body part or over the entire body part.

The radiation marking elements can be in a base state and can be mixed in said base state with the substance, such as the paste or cream, and applied to the object or body part. The radiation marking elements also can be mixed with the substance in an excited state and applied together with the substance to the surface of the object or body part, such that the radiation marking elements can emit radiation, such as infrared radiation, by transitioning to another state, such as the base state. The emitted radiation then can be detected by the at least one camera.

Nanoscopic structures made of a semiconductor material, for example, such as quantum dots, can be used as the radiation marking elements. The charged particles of the radiation marking elements may be spatially restricted in all three spatial dimensions, to such an extent that their energy can no longer assume continuous but only discrete values. The substance that is applied to at least a part of the object, the body or part thereof preferably contains a plurality of quantum dots that can be excited by means of an external radiation source, for example, and can emit radiation, in particular infrared radiation. Quantum dots made of a semiconductor material, such as InGaAs, CdSe, GaInP or InP, can in particular be used as the quantum dots.

Detection of the radiation marking elements may be automatically implemented in a computer system, for example. In this sense, the method can be embodied as a computer program which, when it is loaded onto a computer or is running on a computer, performs a method as described above. The computer program also may be embodied on a computer readable medium.

A device for registering at least a part of an object, such as a body or part thereof, can include at least one camera, preferably at least one infrared camera, and a computational unit such as a computer communicatively coupled to the at least one camera (e.g., wireless or wired communication link between the camera and computational unit). A substance that contains a plurality of radiation marking elements is applied to the object, body or body part, and radiation emitted therefrom can be detected by the at least one camera.

The at least one camera can be arranged and/or configured such that it can detect the radiation, in particular infrared radiation, of at least a part of the plurality of radiation marking elements. The device preferably comprises a camera that is configured to be movable relative to the object or body part.

If the camera is situated at a first position and/or orientation relative to the object, at least a part of the plurality of radiation marking elements can be detected by the camera. The camera can be moved to at least one other position and/or orientation relative to the object or can be positioned in at least one other position and/or orientation, wherein the camera can detect at least another part or all of the plurality of radiation marking elements, in particular at least the radiation marking elements that could not be detected by the camera in the first position.

Preferably, the device comprises two or more cameras that are fixed or movable relative to the object. A first camera can be arranged in at least one first fixed or variable position and/or orientation, wherein the camera can detect at least a part or all of the radiation marking elements. The at least one second camera can be arranged in at least one second fixed or variable position and/or orientation, wherein it can detect at least a second part or all of the radiation marking elements. Preferably, the second camera detects at least the radiation marking elements not detected by the first camera in the at least one first position and/or orientation.

It is also possible to use more than two fixed or movable cameras such that in their respective positions and/or orientations they can detect a part or all of the radiation marking elements. In particular, the movable cameras can be configured such that they can be guided around at least a part of the object or around the part of the object or body part on which the substance is situated.

The position and/or orientation of the at least one camera can be known with respect to a reference coordinate system or can be ascertained with respect to the reference coordinate system. The position and/or orientation of the at least one camera, such as the position and/or orientation of the camera that detects the radiation marking elements, can be known by automatically or manually moving the camera to known predetermined positions and/or orientations. These positions and/or orientations, for example, can be fixedly predetermined or can be recalculated in each registration procedure. Positions and/or orientations can be calculated by means of the computational unit that collects data pertaining to the detected radiation marking elements. Positions and/or orientations can also be calculated in which as few radiation marking elements as possible, such as none, or a predetermined or ideal number of radiation marking elements, or as many radiation marking elements as possible are detected.

Preferably, the computational unit can ascertain desired positions in which the at least one camera can be positioned so as to enable detection of all the radiation marking elements once, twice, three times or four times while minimizing the number of recordings. In particular, it is possible to predetermine or ascertain how many times a radiation marking element has to be detected in order to ascertain its three-dimensional spatial position.

The computational unit, for example, can ascertain a first desired position of the camera such that as many radiation marking elements as possible are detectable by the camera. The computational unit also can ascertain a second desired position of the camera such that as many radiation marking elements as possible are again detectable by the camera. The computational unit also can ascertain a third desired position of the camera from which as few radiation marking elements as possible are detectable by the camera. In the third position, however, at least those radiation marking elements that have only been detected once (e.g., detected in the first position or the second position of the camera) are detectable. This can minimize the number of recordings and thus minimize the time required for registration.

The position and/or orientation of the camera can also be ascertained by arranging a tracking reference or reference star on the camera. The position and/or orientation of the tracking reference/reference star relative to the reference coordinate system or relative to a global coordinate system can be detected and ascertained by a tracking system. Therefore, the position and/or orientation of the camera relative to the reference coordinate system or global coordinate system can also be ascertained.

Taking into account the ascertained position and/or orientation of the at least one camera, and based on detection of the radiation marking elements by the at least one camera, the computational unit can ascertain the three-dimensional spatial positions of the plurality of radiation marking elements on the surface of the object relative to the reference coordinate system or global coordinate system. Preferably, the radiation marking elements are detected from a sufficient number of different positions and/or orientations of the camera such that all or substantially all of the radiation marking elements are detected at least once, twice or three times, or a sufficient number of times to enable reconstruction of the surface of the object or body part.

The computational unit can correlate the detected radiation marking elements with the ascertained positions of the camera that recorded the radiation marking elements, such that the three-dimensional spatial position of the radiation marking elements relative to the reference or global coordinate system can be deduced. The surface of the body part or object can be deduced from the three-dimensional spatial positions of the radiation marking elements, and the object or body part or the surface of the object or body part can be registered, for example, with previously obtained recordings of the object or body part.

The device also can include an excitation source that can emit radiation of a predetermined frequency or predetermined frequency spectrum. The radiation of the excitation source can exhibit a frequency such that it can excite the radiation marking elements, such as the quantum dots, into a state in which the radiation marking elements or quantum dots emit a radiation, in particular an infrared radiation. This emitted radiation can be detected by the at least one camera. The excitation source can be configured to be fixed or movable and, for example, can be arranged on the at least one camera or integrated into the at least one camera.

### BRIEF DESCRIPTION OF THE DRAWINGS

The forgoing and other features of the invention are hereinafter discussed with reference to the drawing.

FIG. 1 is a schematic diagram of an exemplary system in accordance with the invention for registering a part of an object, such as a patient's face.

### DETAILED DESCRIPTION

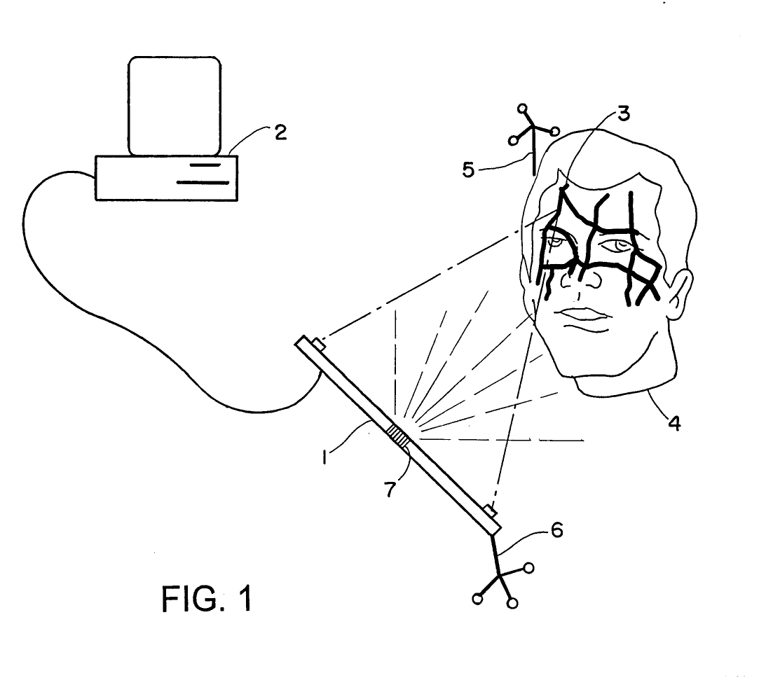

FIG. 1 shows an exemplary system for registering an object, such as a patient or part of a patient's body. The system includes a camera 1, such as an infrared camera 1, which is communicatively coupled to a computer 2. A cream, paint, liquid, paste, gel or the like is applied to a part of a patient's body (e.g., to the patient's face 4) in a predetermined or ascertainable pattern. Further, a trackable device such as a reference star 5 or the like may be attached to the patient (e.g., to the patient's head), and a second reference star 6 may be attached tot he camera 1. The cream contains a plurality of quantum dots 3, which when excited emit infrared radiation that can be detected by the infrared camera 1.

The spatial position of the infrared camera 1 relative to a reference or global coordinate system is known to the computer 2. Alternatively, the position of the camera 1 may be determined by a tracking system (not shown) that tracks a reference array 6 attached to the camera, wherein the tracking system provides the spatial position to the computer 2. The position of the patient 4 may be known or ascertained by ascertaining the position and/or orientation of the reference star 5 arranged on the patient's head.

The infrared camera 1, when placed in a first position, can detect at least a part or all of the quantum dots 3 by detecting infrared radiation emitted by the quantum dots 3. Data collected by the camera 1 may be provided to the computer 2.

The camera may include an exciter 7 for exciting the radiation marking elements such that they emit radiation. The excited 7 may be arranged on or in the camera 1.

The computer 2 can ascertain the three-dimensional spatial position of the detected quantum dots 3 from the position of the camera 1 relative to the reference coordinate system and from the detected infrared radiation. The infrared camera 1 also can be moved to another position in which it can detect another part of the quantum dots 3 and then provide the data to the computer 2, such that the three-dimensional spatial position of the quantum dots 3 detected in the second position also can be ascertained by the computer 2.

The quantum dots 3 are preferably detected from at least two different positions of the camera 1, such that the spatial position of the quantum dots 3 can be deduced from the detected radiation in the different recording positions of the camera 1. If most or all of the spatial positions of the quantum dots 3 are known relative to the reference or global coordinate system, then the computer 2 can reconstruct or ascertain the surface of the patient's face 4 from the ascertained positions of the quantum dots 3.

The surface of the patient's face 4 is thus known in three-dimensional space and can be registered with other patient data sets. These patient data sets may include, for example, pre-operatively obtained recordings or recordings of the patient taken by means of imaging methods.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method for registering at least a part of an object, comprising:
applying a substance to at least a part of the surface of the object, wherein the substance includes a plurality of radiation marking elements that emit radiation;
using at least one camera to scan the surface of the object such that at least a portion of the plurality of radiation marking elements are detected by the at least one camera;
ascertaining three-dimensional spatial positions of the detected portion of the plurality of radiation marking elements relative to a reference coordinate system based on the detected radiation emitted from the marking elements and a three-dimensional position and/or orientation of the camera relative to the reference coordinate system; and
registering the object on the basis of the three-dimensional spatial positions of the detected portion of the plurality of radiation marking elements.

2. The method of claim 1, wherein using at least one camera includes ascertaining or knowing a three-dimensional position and/or orientation of the at least one camera relative to the reference coordinate system.

3. The method according to claim 1, wherein the object is a patient's body or part thereof.

4. The method according to claim 1, wherein applying the substance that includes radiation marking elements includes using a substance that having radiation marking elements that emit infrared radiation.

5. The method according to claim 4, wherein using the camera to detect radiation includes detecting infrared radiation.

6. The method according to claim 1, wherein using at least one camera includes using a camera that is fixed or movable relative to the object.

7. The method according to claim 6, wherein using the movable camera includes guiding the camera around at least a part of the object to detect at least the portion of the plurality of radiation marking elements.

8. The method according to claim 1, wherein using the at least one camera includes using different positions or orientations of the at least one camera to detect the plurality of radiation marking elements.

9. The method according to claim 1, wherein applying the substance includes using a substance in the form of a paint, liquid, gel, cream or paste.

10. The method according to claim 1, wherein applying the substance includes using a substance that includes a uniform distribution of radiation marking elements.

11. The method according to claim 4, wherein the radiation marking elements emit radiation in at least one excited state.

12. The method according to claim 1, wherein applying the substance includes using a substance that comprises a plurality of quantum dots, and the quantum dots are detected by the at least one camera as the plurality of radiation marking elements.

13. The method according to claim 12, wherein using the substance that comprises a plurality of quantum dots includes forming the quantum dots from semiconductor material.

14. The method according to claim 13, wherein forming the quantum dots from semiconductor material includes using at least one of InGaAs, CdSe, GaInP or InP as the semiconductor material.

15. A computer program embodied on a computer readable medium for registering at least a part of an object, wherein a substance is applied to at least a part of the surface of the object, the substance including a plurality of radiation marking elements that emit radiation, comprising:
code that directs at least one camera to scan the surface of the object such that at least a portion of the plurality of radiation marking elements are detected by the at least one camera;
code that ascertains three-dimensional spatial positions of the detected portion of the plurality of radiation marking elements relative to a reference coordinate system based on the detected radiation emitted from the marking elements and a three-dimensional position and/or orientation of the camera relative to the reference coordinate system; and
code that registers the object on the basis of the three-dimensional spatial positions of the detected portion of the plurality of radiation marking elements.

16. A device for registering at least a part of an object in a medical workspace, comprising:
at least one camera operative to detect radiation emitted from at least a portion of a plurality of radiation emitting marking elements contained within a substance applied or appliable to the object, wherein a three-dimensional position and/or orientation of the at least one camera is known or can be ascertained relative to a reference coordinate system; and
a computational unit communicatively coupled to the at least one camera and operative to ascertain three-dimensional spatial positions of the plurality of radiation marking elements relative to a reference coordinate system based on detection of the radiation marking elements by the at least one camera and the three-dimensional position and/or orientation of the camera relative to the reference coordinate system, said computational unit further operative to register the object based on the three-dimensional spatial positions of the plurality of radiation marking elements.

17. The device of claim 16, wherein the at least one camera is operative to detect infrared radiation.

18. The device of claim 16, wherein the object is a patient's body or part of a patient's body.

19. The device according to claim 16, wherein the at least one camera is at least two cameras.

20. The device according to claim 16, wherein the at least one camera is fixed or movable relative to the object.

21. The device according to claim 16, wherein the at least one camera is configured such that it can be guided around at least a part of the object in order to detect at least a portion of the plurality of radiation marking elements.

22. The device according to claim 16, comprising a tracking system for detecting a three-dimensional spatial position of a reference star arranged on the camera.

23. The device according to claim 16, comprising an excitation source that can excite the plurality of radiation marking elements contained in the substance into at least one excited state such that the plurality of radiation marking elements emit radiation.

24. The device according to claim 23, wherein the radiation emitted by the radiation marking elements is infrared radiation.

25. The device according to claim 23, wherein the excitation source is arranged on the at least one camera or contained in or integrated into the at least one camera.
